(19) United States
(12) Patent Application Publication
(10) Pub. No.: US 2004/0169776 A1
(43) Pub. Date: Sep. 2, 2004

(54) Television tuner unit having a small motherboard-mounted surface area

(75) Inventor: Masaki Yamamoto, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/783,878

(22) Filed: Feb. 20, 2004

(30) Foreign Application Priority Data
Feb. 27, 2003 (JP) 2003-000964

(51) Int. Cl. H04N 5/50

(52) U.S. Cl. 348/836; 348/731

(57) ABSTRACT

A television tuner unit includes a tuner that frequency-converts a received television signal into an intermediate-frequency (IF) signal, a video IF circuit that demodulates the IF signal, and a conductive frame having four side plates that houses the tuner and the video IF circuit. The internal space of the frame is divided into first and second regions that face each other, the first region being more proximate to the first side plate than the second region. The video IF circuit and the tuner are provided in the first and second regions, respectively. A connector through which the television signal is input is formed on the third side plate at a position corresponding to the second region. Terminals connected with the tuner and the video IF circuit are formed on the first side plate.

This application claims the benefit of priority to Japanese Patent Application No. 2003-000964, herein incorporated by reference in its entirety.

### BACKGROUND OF THE INVENTION

1. Field of the Invention

The present invention relates to television tuner units, and more specifically relates to a television tuner unit including a tuner for frequency-conversion of a received television signal into an intermediate-frequency (IF) signal, and a video IF circuit for demodulating the IF signal and outputting a video signal and an audio signal.

2. Description of the Related Art

FIG. 2 is a plan view of a television (TV) tuner unit of the related art, showing the circuit arrangement thereof. In a rectangular metal frame 11 having first to fourth side plates 11a to lid, the first side plate 11a and second side plate 11b on the longer side of the metal frame 11 face each other, and the third side plate 11c and fourth side plate 11d on the shorter side of the metal frame 11 face each other. The third plate 11c has a connector 12 through which a television signal is input.

The internal space of the metal frame 11 is divided into adjacent first and second regions 11e and 11f by a shield plate 13 extending between the first side plate 11a and the second side plate 11b. The first region 11e is formed on the side of the third side plate 11c having the connector 12, and the second region 11f is formed on the side of the fourth side plate 11d. Although not shown in FIG. 2, the first region 11e is further divided into a plurality of sub-regions by smaller shield plates. The first side plate 11a has a plurality of terminals 14 that are arranged in a row with a predetermined spacing therebetween. The metal frame 11 houses a circuit board (not shown) having circuits, and the shield plate 13 stands on the circuit board.

The first region lie includes a tuner 15 for frequency-converting a received television signal into an intermediate-frequency (IF) signal, and the second region 11f includes a video IF circuit 16 for demodulating the IF signal and outputting a video signal and an audio signal. The terminals 14 are connected to the tuner 15 and the video IF circuit 16. Each of the tuner 15 and the video IF circuit 16 has different circuit structures depending upon the application.

The TV tuner unit is mounted on a TV receiver motherboard (not shown) by connecting the terminals 14 to the motherboard.

In the TV tuner unit of the related art, the first region lie and the second region 11f are adjacently formed along the first side plate 11a having the terminals 14. Therefore, a large space corresponding to the area of the first side plate 11a is required in the TV receiver motherboard in order to install the TV tuner unit.

### SUMMARY OF THE INVENTION

Accordingly, embodiments of the present invention provide a television tuner unit having a small surface mounted on a motherboard of a television receiver.

The present invention provides a television tuner unit including a tuner that frequency-converts a received television signal into an intermediate-frequency signal, a video intermediate-frequency circuit that demodulates the intermediate-frequency signal and outputs a video signal and an audio signal, and a conductive frame having first to fourth side plates that house the tuner and the video intermediate-frequency circuit. The internal space of the frame is divided into a first region and a second region that face each other. The first region is disposed more proximate to the first side plate than the second side plate. The video intermediate-frequency circuit is provided in the first region, and the tuner is provided in the second region. The third side plate contains a first portion forming the first region and a second portion forming the second region. A connector is provided at the second portion. The first side plate has a plurality of terminals connected with the tuner and the video intermediate-frequency circuit.

This allows the tuner and the video intermediate-frequency circuit to be accommodated in a space corresponding to the area of the first side plate having the terminals, thus reducing the space required in a television receiver motherboard in order to install the television tuner unit.

The first region and the second region may be separated from each other by a shield plate extending between the third side plate and the fourth side plate, resulting in less interference between the tuner and the video intermediate-frequency circuit. The first and second regions may be substantially the same size and shape.

The tuner may include a mixer circuit for frequency conversion, and the video intermediate-frequency circuit may include a SAW filter. The mixer circuit may be positioned in the second region more proximate to the fourth side plate than the third side plate, and the SAW filter may be positioned in the first region more proximate to the fourth side plate than the third side plate, resulting in the minimum connection distance between the mixer circuit and the SAW filter. The SAW filter may be positioned adjacent to the mixer circuit.

### BRIEF DESCRIPTION OF THE DRAWINGS

FIG. 1 is a plan view of a TV tuner unit of the present invention; and

FIG. 2 is a plan view of a TV tuner unit of the related art.

### DESCRIPTION OF THE PREFERRED EMBODIMENTS

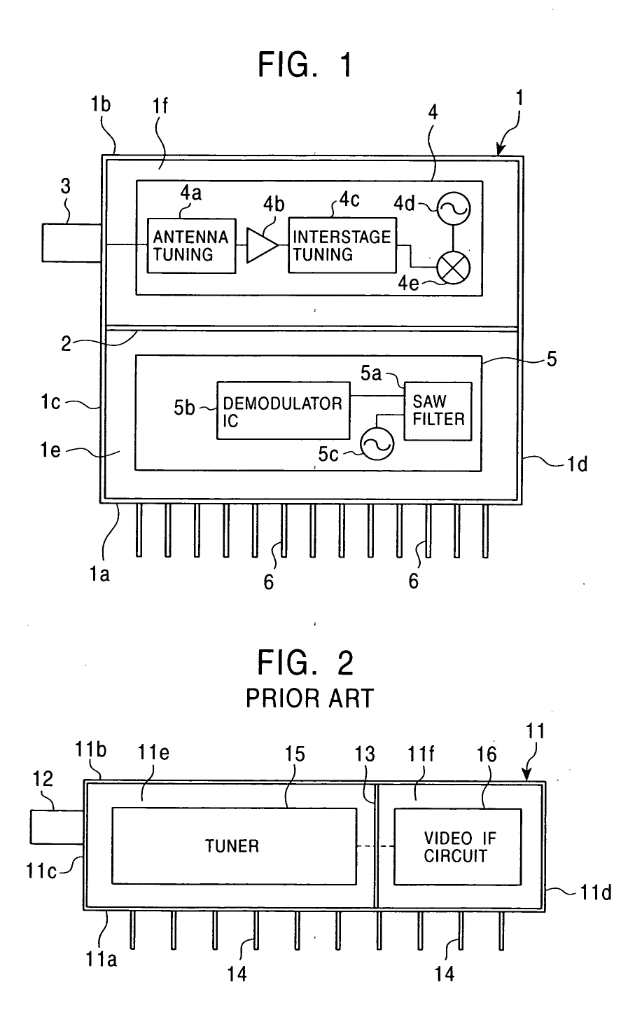

FIG. 1 is a plan view of a television (TV) tuner unit according to the present invention, showing the circuit arrangement thereof. A rectangular metal frame 1 has a pair of a first side plate 1a and a second side place 1b facing each other, and another pair of a third side plate 1c and a fourth side plate 1d facing each other. The internal space of the metal frame 1 is divided into a first region 1e on the side of the first side plate 1a and a second region 1f on the side of the second side plate 1b by a shield plate 2 extending between the third side plate 1c and the opposing fourth side plate 1d.

The third side plate 1c has a connector 3 at the position corresponding to the second region 1f, through which a television signal is input. The metal frame 1 houses a circuit board (not shown) having circuits. The second region 1f is further divided into a plurality of sub-regions by smaller shield plates, although not shown in FIG. 1.

The second region 1f includes a tuner 4 on the circuit board for frequency-converting the received television signal into an IF signal. The tuner 4 includes an antenna tuning circuit 4a, a high-frequency amplifier circuit 4b, an interstage tuning circuit 4c, an oscillator circuit 4d, a mixer circuit 4e, and so on, and these circuits are designed so as to comply with standards used in different countries such as NTSC (National Television Standards Committee—used in the United States, for example) or PAL (Phase Alternating Line). The antenna tuning circuit 4a is positioned near the connector 3, and the oscillator circuit 4d and the mixer circuit 4e are positioned on the side of the fourth side plate 1d.

The first region 1e includes a video IF circuit 5 on the circuit board for demodulating the IF signal and outputting a video signal and an audio signal. The video IF circuit 5 includes a SAW (surface acoustic wave) filter 5a, a demodulator IC (integrated circuit) 5b, an oscillator circuit 5c, and so on, and these circuits are designed so as to comply with the applicable standard such as NTSC or PAL. In the first region 1e, the SAW filter 5a is positioned on the side of the fourth side plate 1d.

The first side plate 1a has a plurality of terminals 6 such that the terminals 6 are arranged in a row with a predetermined spacing therebetween. The terminals 6 are connected with the tuner 4 and the video IF circuit 5 so as to supply power to the tuner 4 and the video IF circuit 5, to input a channel selection signal to the tuner 4, and to output the video signal and audio signal from the video IF circuit 5.

The video IF circuit 5 in the first region le and the tuner 4 in the second region if are accommodated in a space corresponding to the area of the first side plate 1a having the terminals 6. Therefore, the space required in the motherboard of the TV receiver in order to install the TV tuner unit can be reduced.

The first region 1e and the second region 1f are separated from each other by the shield plate 2, resulting in less interference between the tuner 4 and the video IF circuit 5.

In this structure, the television signal input via the connector 3 is selected and processed by the tuner circuits 4a and 4c and is also amplified by the high-frequency amplifier circuit 4b. The resulting signal is further converted into an IF signal by the mixer circuit 4e. The IF signal output from the mixer circuit 4e is input to the SAW filter 5a, and is then demodulated by the subsequent demodulator IC 5b into a video signal and an audio signal. Since the mixer circuit 4e of the tuner 4 and the SAW filter 5a of the video IF circuit 5 are adjacently positioned on the side of the fourth side plate 1d, the connection distance between the mixer circuit 4e and the SAW filter 5a can be minimized. The video signal and the audio signal are output via the terminals 6.

What is claimed is:

1. A television tuner unit comprising:
a tuner that frequency-converts a received television signal into an intermediate-frequency signal;
a video intermediate-frequency circuit that demodulates the intermediate-frequency signal and from which a video signal and an audio signal is output; and
a conductive frame having first, second, third and fourth side plates that house the tuner and the video intermediate-frequency circuit, the first and second side plates facing each other,
wherein an internal space of the frame is divided into a first region and a second region, the first region is disposed more proximate to the first side plate than the second side plate, the video intermediate-frequency circuit is provided in the first region and the tuner is provided in the second region,
the third side plate contains a first portion forming the first region and a second portion forming the second region, a connector is provided at the second portion, the connector permitting the television signal to be input, and
the first side plate has a plurality of terminals connected with the tuner and the video intermediate-frequency circuit.

2. A television tuner unit according to claim 1, wherein the first region and the second region are separated from each other by a shield plate extending between the third side plate and the fourth side plate.

3. A television tuner unit according to claim 1, wherein the tuner includes a mixer circuit for frequency conversion, the mixer circuit is positioned in the second region more proximate to the fourth side plate than the third side plate, and the video intermediate-frequency circuit includes a SAW filter in the first region more proximate to the fourth side plate than the third side plate.

4. A television tuner unit according to claim 1, wherein the first and second regions are substantially the same size and shape.

5. A television tuner unit according to claim 1, wherein the tuner and the video intermediate-frequency circuit are each accommodated in a space corresponding to an area of the first side plate.

6. A television tuner unit according to claim 3, wherein the SAW filter is positioned adjacent to the mixer circuit.

7. A television tuner unit according to claim 6, wherein a shield plate is disposed between the SAW filter and the mixer circuit.

8. A television tuner unit comprising:
a tuner that frequency-converts a television signal into an intermediate-frequency signal;
means for introducing the television signal to the tuner;
a video intermediate-frequency circuit that demodulates the intermediate-frequency signal and from which a video signal and an audio signal is output;
a plurality of terminals configured to supply power to the tuner and the video intermediate-frequency circuit, to input a channel selection signal to the tuner, and through which the video signal and audio signal are output; and
a conductive frame that houses the tuner and the video intermediate-frequency circuit in separate compartments, the tuner disposed in a first compartment and the video intermediate-frequency circuit disposed in a second compartment that is more proximate to the terminals than the first compartment.

9. A television tuner unit according to claim 8, further comprising means for shielding at least one of the compartments from undesired electromagnetic radiation originating in another of the compartments.

10. A television tuner unit according to claim 9, wherein the tuner includes a mixer circuit disposed proximate to a side of the frame most distal from the introducing means and the video intermediate-frequency circuit includes a SAW filter disposed on the same side of the frame as the mixer circuit.

11. A television tuner unit according to claim 8, wherein the first and second compartments are substantially the same size and shape.

12. A television tuner unit according to claim 8, wherein an area of the first and second compartments is substantially equal to an area of a portion of the frame on which the terminals are mounted.
